(19) United States
(12) Patent Application Publication
(10) Pub. No.: US 2026/0326316 A1
(43) Pub. Date: Oct. 22, 2026

(54) Vorrichtung Zum Halten eines Objektes

(71) Applicant: Formhand Automation GmbH, Braunschweig (DE)

(72) Inventor: Holger KUNZ, Braunschweig (DE)

(21) Appl. No.: 19/577,931

(22) Filed: Mar. 25, 2026

(30) Foreign Application Priority Data
Apr. 3, 2025 (DE) 10 2025 113 146.5

(51) Int. Cl. B25J 15/06

(52) U.S. Cl. CPC B25J 15/0625; B25J 15/0683

(57) ABSTRACT

The invention relates to a device for holding an object, the device comprising an annular molding cushion (2) that
contains a granulate (4) and
surrounds a suction chamber (6) open on at least one side,

wherein the molding cushion (2) and the suction chamber (6) comprise a connector (12, 26) for a negative pressure source,

characterized in that

the suction chamber (6) is covered on the open side by a cover (40) that is permeable to air.

The invention relates to a device for holding an object, the device comprising an annular molding cushion that contains a granulate and surrounds a suction chamber open on at least one side, wherein the molding cushion and the suction chamber each have a connection for a negative pressure source.

Such devices are known from the prior art and are used to hold, handle and/or transport objects. If an object is to be held by the device, the molding cushion is brought into contact with the object. The molding cushion is made from a flexible and/or elastic material and therefore deforms under the pressure exerted by the object on the molding cushion. This causes the granulate inside the molding cushion to move. A negative pressure is subsequently applied to the molding cushion. The negative pressure comes from a negative pressure source, such as a pump, which may constitute part of the device, but does not have to be constitute part of the device. Such devices are often used as robot end effectors in production facilities that can be connected to a central negative pressure supply or have a pump themselves. By applying the negative pressure to the molding cushion, the air is suctioned out of the molding cushion and the molding cushion solidifies in the position that it has assumed by coming into contact with the workpiece to be gripped. In this way, the device adapts very effectively to the external form, geometry and/or shape of the object.

Initially, such devices featured a molding cushion with a large end face that was preferably placed in full contact with the object to be held in order to deform the molding cushion. A further development of such devices comprises an annular molding cushion. An annular molding cushion may be designed to be circular, although this is not strictly necessary. Annular means that a cross-section through the molding cushion comprises a closed outer contour and a closed inner contour. For example, the outer contour is formed by an outer wall and the inner contour by an inner wall. The volume holding the granulate is located between the inner wall and the outer wall. The molding cushion is fixed to a mount on one side, said mount serving to assemble the device on another component, such as a robotic arm. On the opposite side, the molding cushion is limited by an end face. The end face is usually there to come into contact with the object to be held.

Within the inner wall is the suction chamber that is surrounded by the molding cushion and limited by the inner wall of the molding cushion. The suction chamber has a connector for a negative pressure source. Said connector is preferably positioned on the side of the suction chamber that faces the device mount. On the opposite side, which faces the object to be held, the suction chamber is open.

When an object is held, the negative pressure applied to the molding cushion ensures that the molding cushion solidifies and thus remains in the shape adapted to the object. The negative pressure applied to the suction chamber exerts a suction effect on the object to be held. This force holds the object in place on the device.

The properties and characteristics described above not only exist and are advantageous in the prior art, but are also advantageous for devices according to embodiment examples of the present invention.

The disadvantage is that such devices may cause deformations of the object to be held, especially in the area of the suction chamber, in particular if the object itself is very flexible. This may lead to permanent deformations, such as buckling or bending, or even to damage to the object.

The invention therefore aims to further develop a device according to the preamble in such a way that even flexible objects are more effectively protected.

The invention solves the addressed task by way of a device with the characteristics of the preamble of claim 1, which is characterized in that the suction chamber is covered on the open side by a cover that is permeable to air. Such a cover means that the suction effect, and therefore the holding force exerted on the object by the negative pressure in the suction chamber, continues to be exerted on the object. In this case, this refers to a suction chamber that is open on one side. As a result of the permeable cover, even highly flexible objects are not suctioned so strongly into the suction chamber, or at least not as strongly as in the prior art, thus preventing deformations and damage. The permeable cover is preferably made of a flexible, but inelastic, material. This allows it to follow the changing shape of the molding cushion as it adapts.

Preferably, the permeable cover is made of a textile, particularly preferably a woven fabric.

The permeable cover is preferably arranged on the molding cushion, particularly glued and/or welded onto it.

In one preferred embodiment, the molding cushion has an inner wall facing the suction chamber, an outer wall facing away from the suction chamber, and an end face that connects the inner wall and the outer wall, wherein the permeable cover is arranged at an edge between the inner wall and the end face.

The permeable cover preferably comprises at least one stabilizing strip which has a higher degree of stiffness, especially bending stiffness, than the remaining part of the permeable cover. Particularly preferably, at least one stabilizing strip extends from the inner wall of the molding cushion to the inner wall of the molding cushion.

It has been proven to be advantageous if negative pressure can be applied separately to the molding cushion and the suction chamber.

Preferably, the molding cushion and the suction chamber have a common connector for a negative pressure source, the device preferably comprising a valve through which the negative pressure can be applied to the molding cushion and/or the suction chamber. The device then comprises a single connector that can be connected to a negative pressure source and via which the negative pressure can be applied to both the molding cushion and the suction chamber when a negative pressure source is connected to the connector. From the connector, there is a partial line that extends to the molding cushion and another partial line that extends to the suction chamber. Both partial lines form part of the common line that starts at the connector. The valve is preferably arranged at the branching point. The valve is preferably configured to supply the negative pressure either only to the molding cushion or only to the suction chamber. In addition, the valve is preferably configured to supply the negative pressure to both the molding cushion and the suction chamber; particularly preferably, the valve is able to supply the negative pressure to the molding cushion and the suction chamber at different intensities. This can be achieved, for example, in that the valve modifies the flow resistance in the partial line leading to the molding cushion and the flow resistance in the partial line leading to the suction chamber. This can be achieved, for example, with one or multiple throttle valves.

A method for holding an object, in which a device according to one embodiment example of the present invention is used, constitutes a separate invention. Here, the molding cushion is first adapted to the geometry, the outer form and/or the shape of the object to be held. Preferably, this is achieved by bringing the molding cushion into contact with the object, wherein negative pressure is not yet applied to the molding cushion. It is flexible and deformable, so it adapts to the object.

In this state, negative pressure is applied to the suction chamber. As a result, even at this early stage, a holding force is exerted on the object, which may also cause the molding cushion to further adapt to the form, geometry and/or shape of the object.

Following this deformation of the molding cushion, the negative pressure is applied to the molding cushion. As described above, this causes the molding cushion to lose its flexibility and become fixed in the form it assumes. The fact that the negative pressure has already been applied to the suction chamber also prevents the molding cushion from moving relative to the object as it solidifies.

Releasing the object from the device is preferably this process in reverse. Once the object has been held long enough, the negative pressure is first removed from the suction chamber. To achieve this, it may be sufficient to close a valve in the line through which an externally applied negative pressure is supplied to the suction chamber. Alternatively, the suction chamber can be ventilated, for example by opening a connection between the suction chamber and the surroundings. This results in an equalization of pressure and the holding force acting on the object, which is generated by the negative pressure in the suction chamber, cannot be maintained. Preferably, it is only after this step, or at least at a later time, that the negative pressure is no longer applied to the molding cushion or it is even ventilated.

Preferably, an annular sealing lip is arranged on the molding cushion.

The embodiment is based on the knowledge that the high amount of energy required by devices from the prior art is at least partially due to the fact that the contact between the molding cushion and the object to be held is not sufficiently sealed, even though the molding cushion is almost ideally adapted to the contour, form and shape when the negative pressure is applied. Due to the fact that it is not sufficiently sealed, air flows into the suction chamber where the negative pressure is applied, resulting in a drop in pressure. Such a drop in pressure means that the difference in pressure between the negative pressure provided by a negative pressure source and the ambient pressure decreases. The negative pressure inside the suction chamber therefore becomes weaker, while the pressure inside the suction chamber increases. This leakage is reduced or even completely prevented by the sealing lip according to the invention such that the pressure difference between the pressure in the suction chamber and the ambient pressure required to hold the object decreases and as such can be maintained with less energy.

The sealing lip is designed to be annular. This can mean circular, but this is not strictly necessary. Each closed contour or path along which the sealing lip extends is considered annular within the context of the present invention.

Preferably, the molding cushion has an inner wall facing the suction chamber, an outer wall facing away from the suction chamber, and an end face that connects the inner wall and the outer wall, wherein the sealing lip is arranged on the end face. The end face is usually facing the object to be held. Preferably, the annular sealing ring extends around the opening to the suction chamber.

In one preferred embodiment, the sealing lip is designed as a single piece with the molding cushion. For example, the molding cushion with the sealing can be cast, wherein both the shape of the molding cushion and that of the sealing lip are present in the mold and poured into it.

Alternatively, the sealing lip may also be fixed to the molding cushion, for example glued, welded or fixed in another manner. In this case, it is advantageous for the bond between the sealing lip and the molding cushion to be as tight as possible along the entire length of the sealing lip in order to avoid the leakage described above.

The end face of the molding cushion is in the shape of a ring. It may be a circular ring. This, however, is not essential. The important thing is that the end face forms an opening that provides access to the suction chamber. The ring, formed by the end face, has a width that corresponds to the distance between the inner wall and the outer wall. This width is preferably constant across the circumference. The end face has a radially inner section and a radially outer section. The radially inner section is preferably the radially inner half, the radially inner third or the radially inner quarter of the end face. The radially inner section of the end face is the section of the end face that abuts the edge facing the inner wall. The radially outer section is preferably the radially outer half, the radially outer third or the radially outer quarter of the end face. The radially outer section of the end face is the section of the end face that abuts the edge facing the outer wall.

The sealing lip is preferably arranged in a radially inner section of the end face. This has the advantage that the sealing lip is arranged close to the suction chamber where the negative pressure is applied and which is to be sealed against the surroundings. This arrangement also allows for the use of a relatively long sealing lip without it protruding radially outwards beyond the molding cushion.

In one preferred embodiment, the sealing lip does not protrude radially outwards beyond the molding cushion.

Preferably, the sealing lip comprises a first section in which it curves away from the molding cushion. It also has a second section in which it curves towards the molding cushion. It can therefore act as a spacer between the end face of the molding cushion and the object to be held such that the negative pressure applied to the suction chamber is also applied to the sealing lip.

In the following, a number of embodiment examples of a device for holding an object will be explained in more detail with the aid of the accompanying figures. They show:

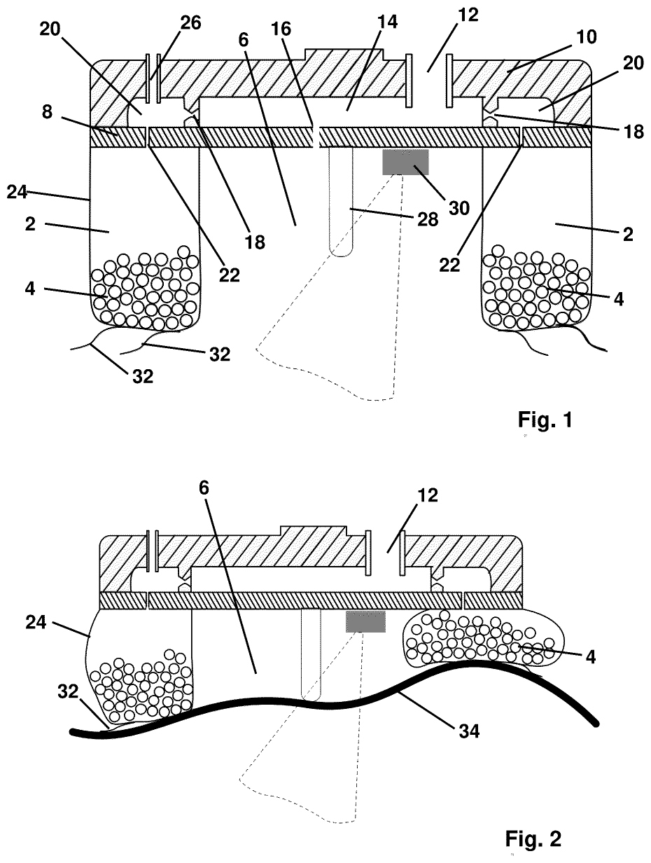

FIG. 1—a schematic sectional representation through such a device according to a first embodiment example,

FIG. 2—a schematic sectional representation of the device from FIG. 1 in contact with an object,

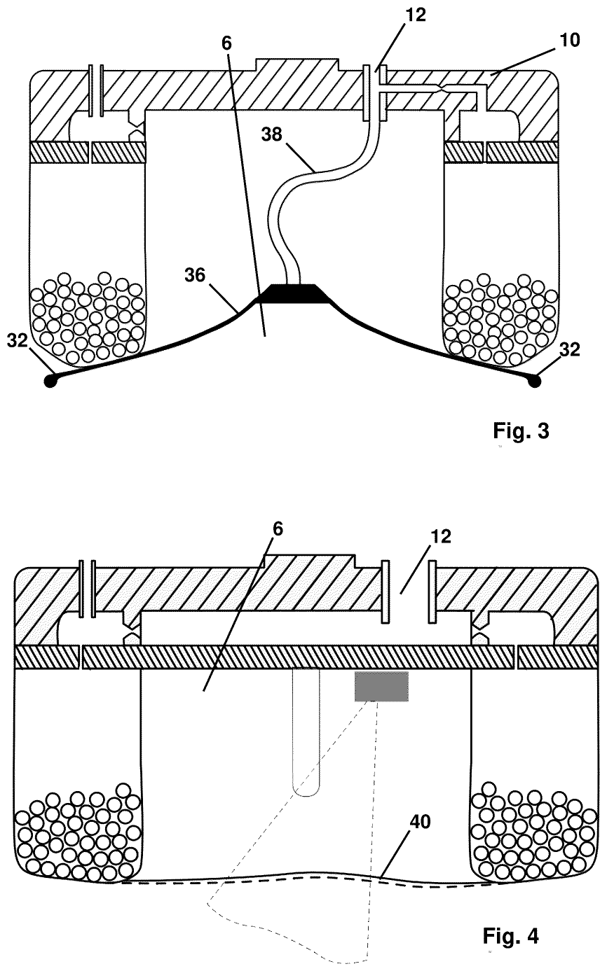

FIG. 3—a schematic sectional representation through such a device according to a second embodiment example,

FIG. 4—a schematic sectional representation through such a device according to a third embodiment example,

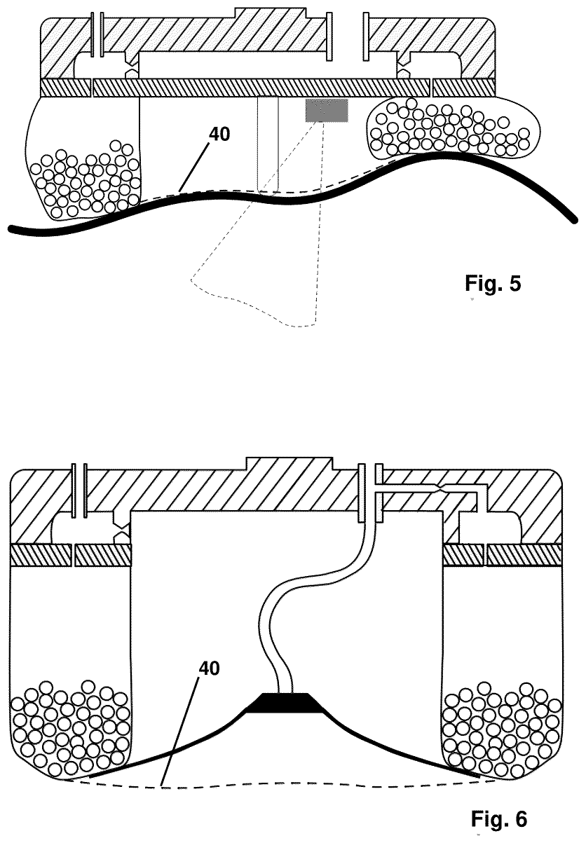

FIG. 5—a schematic sectional representation of the device from FIG. 4 in contact with an object, and

FIG. 6—a schematic sectional representation through such a device according to a fourth embodiment example.

FIG. 1 depicts a schematic sectional view through a device for holding an object. The device comprises an annular molding cushion 2 that contains a granulate 4. The molding cushion 2 surrounds an annular suction chamber 6, which is open at the bottom in FIG. 1. The molding cushion 2 is attached to a connection piece 10 by means of a connecting element 8. The connection piece 10 is arranged, for example, on a robotic arm (not depicted). On the connection piece 10, the device has a connector 12 for a negative pressure source; through said connector, air can be suctioned out of an intermediate chamber 14 between the connection piece 10 and the connecting element 8 when the connector 12 is connected to a negative pressure source. The connecting element 8 has an outlet 16 that connects the intermediate chamber 14 to the suction chamber 6. If a negative pressure is applied to the connector 12 by means of a negative pressure source, such as a pump, connected to the connector 12, air is suctioned out of the intermediate chamber 14 and the suction chamber 6 through the passage 16.

In the embodiment example shown, the connection piece 10 comprises two valves 18 that connect the intermediate chamber 14 to an annular adjacent chamber 20 when the valves 18 are open. The connecting element 8 has two further passages 22 that connect the adjacent chamber 20 to the molding cushion 2. When the valves 18 are open, air is therefore also suctioned out of the molding cushion by a negative pressure source arranged on the connector 12; the granulate 4 is firmly enclosed by the casing 24 of the molding cushion 2. The connection piece also has a second connector 26, which can be connected to a negative pressure source. This renders it possible to apply different negative pressures to the molding cushion 2 and the suction chamber 6 when the valves 18 are closed.

The suction chamber 6 also contains an end stop 28 and a sensor 30 that can be used to monitor an approach to an object to be held. Two sealing lips 32 are arranged on the lower side of the casing 24 in FIG. 1. They seal a contact area between the casing 24 of the molding cushion 2 and an object to be held. This makes it easier to maintain a negative pressure inside the suction chamber 6 that exerts a suction force on the object to be held.

FIG. 2 depicts the situation in which the device from FIG. 1 comes into contact with an object 34. One can see that the sealing lips 32 rest against the object 34. The object 34 is suctioned onto the molding cushion 2 by a negative pressure generated inside the suction chamber 6. A negative pressure created inside the molding cushion ensures that the casing 24 of the molding cushion fits tightly against the granulate 4, thereby preventing the individual elements of the granulate 4 from moving relative to each other.

FIG. 3 shows a schematic sectional representation through such a device according to a second embodiment example. The sealing lip 32 has a thickened area at the end, which improves its sealing properties. The sealing lip 32 forms part of a central sealing element 36 which abuts the suction chamber 6 in the direction of the connection piece 10, rather than the central section of the connecting element 8. The connector 12 is connected to the suction chamber 6 via a line 38.

The third embodiment of a device for holding an object, depicted in a schematic sectional representation in FIG. 4, corresponds largely to the representation in FIG. 1. However, the device shown in FIG. 4 does not have any sealing lips 32. It has a cover 40, which is designed to be permeable to air and abuts the suction chamber 6 at the bottom, i.e. in the direction of an object to be held. Since the cover 40 is permeable to air, a negative pressure created in the suction chamber, said pressure being generated by a negative pressure source (not depicted) arranged on the connector 12, exerts a holding force on the object. The representations in FIGS. 5 and 6 correspond to those in FIGS. 2 and 3. However, the embodiments of the device shown in FIGS. 5 and 6 do not have any sealing lips 32. They each have a cover that is permeable to air.

REFERENCE LIST
2 molding cushion
4 granulate
6 suction chamber
8 connecting element
10 connection piece
12 connector
14 intermediate chamber
16 outlet
18 valve
20 adjacent chamber
22 passage
24 casing
26 second connector
28 end stop
30 sensor
32 sealing lip
34 object
36 sealing element
38 line
40 cover

1. A device for holding an object, comprising:
an annular molding cushion which
contains a granulate;
a suction chamber comprising an opening on at least one side, wherein the annular molding cushion surrounds the suction chamber; and
one or more connectors connectable to a negative pressure source; and
a cover that is permeable to air, wherein the cover covers the opening on the at least one side of the suction chamber.

2. The device according to claim 1, wherein the cover is made from a textile.

3. The device according to claim 1, wherein the cover is arranged on the annular molding cushion.

4. The device according to claim 3, wherein the annular molding cushion comprises
an inner wall facing the suction chamber
an outer wall facing away from the suction chamber and
an end face that connects the inner wall and the outer wall,
wherein the cover is arranged on one side between the inner wall and the end face.

5. The device according to claim 1, wherein the cover comprises at least one stabilizing strip which has a higher degree of stiffness than a remaining part of the cover.

6. The device according to claim 5, wherein the at least one stabilizing strip extends between opposing portions of an inner wall of the annular molding cushion.

7. The device according to claim 1, wherein the device is configured such that negative pressure can be applied separately to the annular molding cushion and the suction chamber.

8. The device according to claim 1, wherein the one or more connectors comprise a common connector for both the annular molding cushion and the suction chamber.

9. The device according to claim 3 wherein the cover is glued or welded onto the annular molding cushion.

10. The device according to claim 8 further comprising a valve through which negative pressure can be applied to the molding cushion and/or the suction chamber.
